(19) United States
(12) Patent Application Publication
(10) Pub. No.: US 2010/0075521 A1
(43) Pub. Date: Mar. 25, 2010

(54) CONDUCTIVE DEVICE FOR COLD CATHODE FLUORESCENT LAMP

(76) Inventors: Chen-Hsuan Hsieh, Hukou Township (TW); De-Hong Chen, Hukou Shiang (TW); Chih-Chung Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,777

(22) Filed: Jan. 8, 2009

(30) Foreign Application Priority Data
Sep. 19, 2008 (TW) 97216981

(51) Int. Cl. H01R 33/02

(52) U.S. Cl. 439/226

(57) ABSTRACT

A conductive device for electrically connecting to a conductive element of at least one cold cathode fluorescent lamp (CCFL) includes at least one coupling terminal and at least one extended conductive segment. The coupling terminal is in the form of an elongated column structure and provided with an insertion bore for receiving the conductive element of the CCFL therein. The extended conductive segment is provided along outer and inner longitudinal edges with a plurality of spaced pairs of upward projected conductive clips. The conductive clips in each pair can hold one coupling terminal therein while the conductive element of the CCFL is received in the insertion bore of the coupling terminal, so that the CCFL conductive device is associated with the CCFL. When a high voltage is applied to the CCFL via the conductive device, discharge occurs in the CCFL to emit light.

### FIELD OF THE INVENTION

The present invention relates to a conductive device, and more particularly to a conductive device for cold cathode fluorescent lamp (CCFL).

### BACKGROUND OF THE INVENTION

In the past few years, the display panel employing the principle of cathode ray tube (CRT) has been largely replaced by the liquid crystal display (LCD). The LCD has many advantages compared to the conventional CRT display panel, including reduced volume and weight, reduced power consumption, free of radiation pollution, etc. The LCD has been widely applied to a variety of products, from small-size information products, such as the LCD screens for personal digital assistants (PDAs), notebook computers, desktop computers, etc. to large-size electronic products, such as LCD televisions.

The LCD includes a display unit, a backlight module located behind the display unit, and an enclosure having a frame. The display unit includes a display panel, a circuit board for processing data signals, and a supporting tape carrier package (TCP). The backlight module includes a cold cathode fluorescent lamp (CCFL), a light-guide plate, a light-diffusion plate, and a light reflection plate.

The CCFL in the backlight module is provided at two opposite ends with a lamp lead wire each to serve as external electrodes. When a high-frequency voltage is applied from a high-frequency power supplying device to the lamp lead wires at two ends of the CCFL, discharge occurs inside the CCFL to release ultraviolet ray, which excites fluorescent powder coated on an internal wall surface of the CCFL to emit light, enabling the CCFL to serve as the light source of the backlight module.

Conventionally, complicated procedures are involved in connecting the lamp lead wires of the CCFL to cables. First, a small length of the plastic sheath at a free end of each of the cables is stripped off to expose the conductive wires in the cable. Then, the bared conductive wires are manually or mechanically twisted. The twisted conductive wires are then curled into a small loop, which is tinned to increase the hardness of the conductive wires. The conductive wires of the cables are then extended through a receiving hole formed on a holder and welded to the lamp lead wires of the CCFL. Finally, the conductive wires are pulled backward to thereby move the lamp lead wires of the CCFL into the receiving hole on the holder.

To enable firm and stable welding of the conductive wires to each of the lamp lead wires of the CCFL when the lamp lead wire of the CCFL is connected to the conductive wires of the cable in the above-described procedures, a sufficient length of the plastic sheath at the free end of the cable must be stripped to expose a long enough length of the conductive wires. And, the conductive wires of the cable must be manually or mechanically twisted and tinned before they are extended through the receiving hole on the holder to be wound around and welded to the lamp lead wire of the CCFL. The above connecting procedures are troublesome and time-consuming to waste a lot of labor. Moreover, the conductive wires of the cables are disorderly arranged to increase the difficulty in assembling and future maintaining the CCFL.

### SUMMARY OF THE INVENTION

It is therefore a primary object of the present invention to provide a modularized conductive device for CCFL, so that a CCFL can be more easily installed in a backlight module to simplify the assembly and reduce the manufacturing cost of the LCD.

To achieve the above and other objects, the conductive device for CCFL according to the present invention includes at least one coupling terminal and at least one extended conductive segment. The coupling terminal is in the form of an elongated column and provided with an insertion bore for receiving a conductive element of a CCFL therein. The conductive element of the CCFL can be a lamp lead wire or a conductive cap. The extended conductive segment is provided along outer and inner longitudinal edges with a plurality of spaced pairs of upward projected conductive clips. The conductive clips in each pair can hold one coupling terminal therein while the conductive element of the CCFL is received in the insertion bore of the coupling terminal, so that the CCFL conductive device is associated with the CCFL. Therefore, when a power is supplied to the CCFL via the conductive device, discharge occurs inside the CCFL to emit light.

In another preferred embodiment of the present invention, the extended conductive segment is provided along an inner longitudinal edge with a plurality of spaced and sidewardly projected portions, and an upward extended joint pin is provided on each of the sidewardly projected portions. And, the CCFL conductive device further includes at least one holding unit. The holding unit includes a holding portion for holding one coupling terminal therein while the coupling terminal is associated with the conductive element of the CCFL. The holding portion is internally provided with a through hole for engaging with the joint pin, so that the joint pin is in electrical contact with the conductive element of the CCFL.

With the technical means adopted by the present invention, the conductive element of the CCFL can be easily associated with the CCFL conductive device. Then, when a high-frequency voltage is applied from a high-frequency power supply to the CCFL via the conductive device of the present invention, discharge occurs in the CCFL, enabling the CCFL to serve as a light source of a backlight module. The CCFL conductive device of the present invention is a modularized product to eliminate the drawback of disordered arrangement of conductive wires as found in the conventional way of assembling the CCFL to cables. Therefore, the backlight module for the LCD can be assembled more easily to save a lot of labor and time and accordingly, reduce the manufacturing cost of the LCD.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an assembled perspective view of a conductive device for CCFL according to a first embodiment of the present invention;

FIG. 2 is a fragmentary exploded view of FIG. 1;

FIG. 3 is an exploded perspective view of a conductive device for CCFL according to a second embodiment of the present invention;

FIG. 4 is a cross-sectional view taken along line 4-4 of FIG. 3;

FIG. 5 is an exploded perspective view of a conductive device for CCFL according to a third embodiment of the present invention;

FIG. 6 is a cross-sectional view taken along line 6-6 of FIG. 5;

FIG. 7 is an assembled perspective view of a conductive device for CCFL according to a fourth embodiment of the present invention;

FIG. 8 is a fragmentary exploded view of FIG. 7;

FIG. 9 is an exploded perspective view of a conductive device for CCFL according to a fifth embodiment of the present invention; and

FIG. 10 is an exploded perspective view of a conductive device for CCFL according to a sixth embodiment of the present invention.

### DETAILED DESCRIPTION OF THE PREFERRED EMBODIMENTS

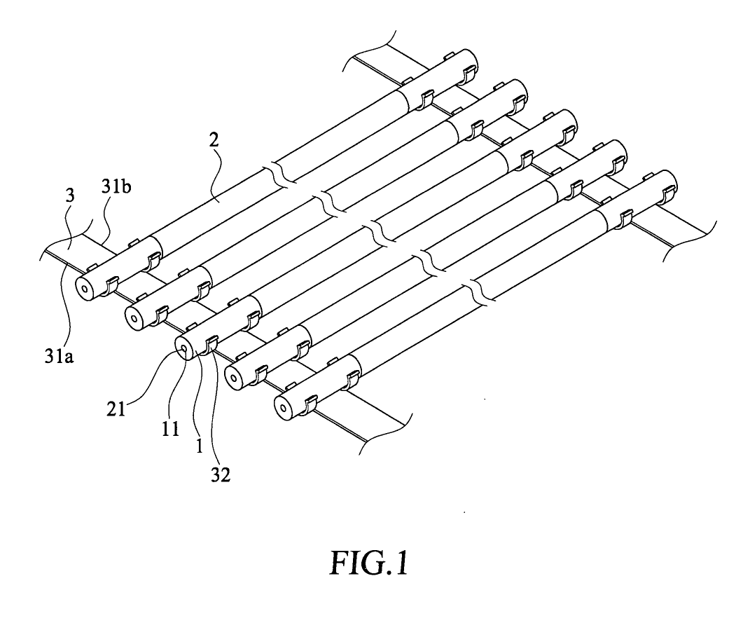

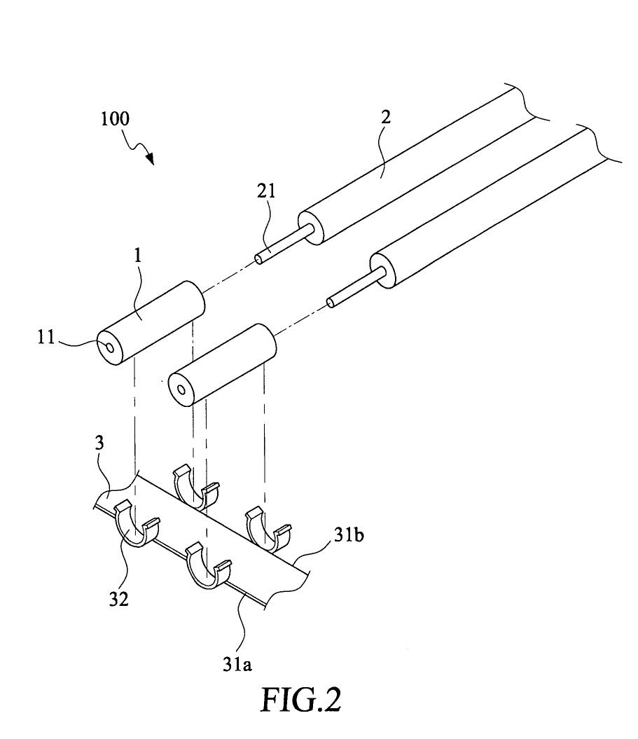

Please refer to FIGS. 1 and 2 that are assembled and exploded perspective views, respectively, showing a conductive device 100 for cold cathode fluorescent lamp (CCFL) according to a first embodiment of the present invention. For the purpose of conciseness, the conductive device for cold cathode fluorescent lamp according to the present invention will also be briefly referred to as the CCFL conductive device herein. The CCFL conductive device 100 includes at least one coupling terminal 1, a main body of which is in the form of an elongated column structure and made of an electrical conductive material. The coupling terminal 1 includes an insertion bore 11 having predetermined diameter and depth for a conductive element 21 of a CCFL 2 to insert and connect thereto. The conductive element 21 of the CCFL 2 can be a lamp lead wire serving as an external electrode of the CCFL 2. And, the conductive element 21 is provided to each of two ends of the CCFL 2 for electrically connecting the CCFL to a power source.

As shown, the CCFL conductive device 100 further includes at least one extended conductive segment 3. The extended conductive segment 3 is provided along an outer and inner longitudinal edges 31a, 31b thereof with a plurality of spaced pairs of conductive clips 32. The conductive clips 32 included in each pair are correspondingly and oppositely located at and upward extended from the two longitudinal edges 31a, 31b of the conductive segment 3 for clamping one coupling terminal 1 therein, so that the CCFL conductive device 100 is associated with the CCFL 2. It would be apparent to a person skilled in the art that two and more CCFLs 2 can also be associated with the CCFL conductive device 100 of the present invention in the above-described manner. In addition, the CCFL conductive device 100 can be connected to an inverter, so that a predetermined amount of working current can be input via the inverter to flow through the extended conductive segment 3 to the CCFL 2, enabling the CCFL 2 to electrically connect to a power supply and emit fluorescent light for use as a light source of illumination.

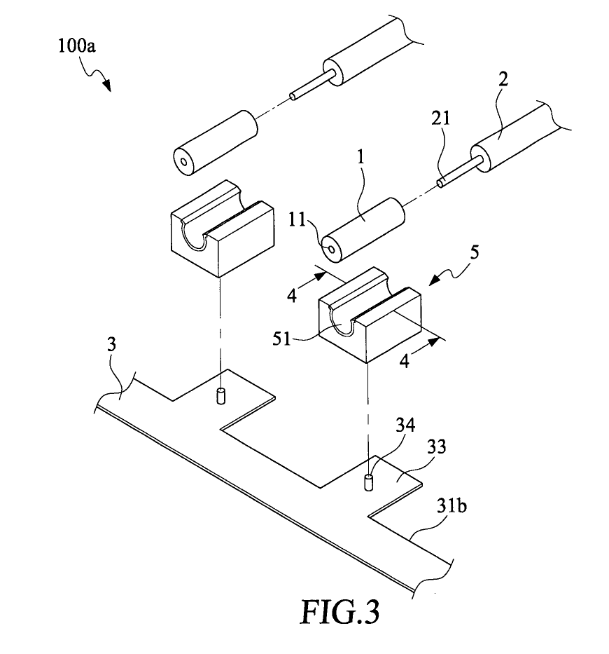

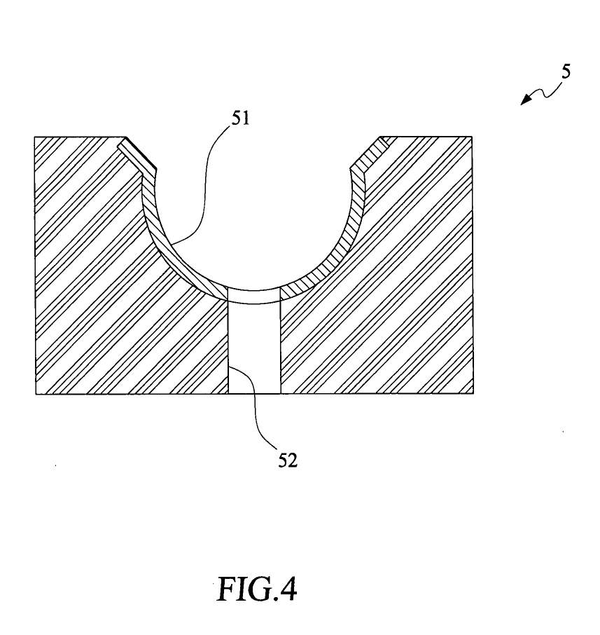

Please refer to FIG. 3 that is an exploded perspective of a CCFL conductive device 100a according to a second embodiment of the present invention, and to FIG. 4 that is a cross-sectional view taken along line 4-4 of FIG. 3. The CCFL conductive device 100a is structurally and functionally similar to the first embodiment, and parts that are the same in the two embodiments will be denoted by the same reference numerals herein. The CCFL conductive device 100a is different from the CCFL conductive device 100 in that the extended conductive segment 3 in the second embodiment is provided along the inner longitudinal edge 31b with a plurality of spaced and sidewardly projected portions 33. And, each of the sidewardly projected portions 33 has an upward extended joint pin 34 provided thereon. The CCFL conductive device 100a further includes at least one holding unit 5, each of which has a holding portion 51. In the illustrated second embodiment, the holding portion 51 is in the form of a concaved recess, and portions of the holding unit 5 outside the holding portion 51 are made of an insulative material. The holding portion 51 is internally provided with a through hole 52. As can be seen from FIG. 4, the holding portion 51 of the holding unit 5 is designed to holding one coupling terminal 1 therein while the conductive element 21 of the CCFL 2 is inserted in and connected to the coupling terminal 1. The through hole 52 is provided for engaging with the joint pin 34 provided on each of the sidewardly projected portions 33, so that the joint pin 34 is in electrical contact with the conductive element 21 of the CCFL 2. It would be apparent to a person skilled in the art that two and more CCFLs 2 can also be associated with the CCFL conductive device 100a in the second embodiment of the present invention in the above-described manner.

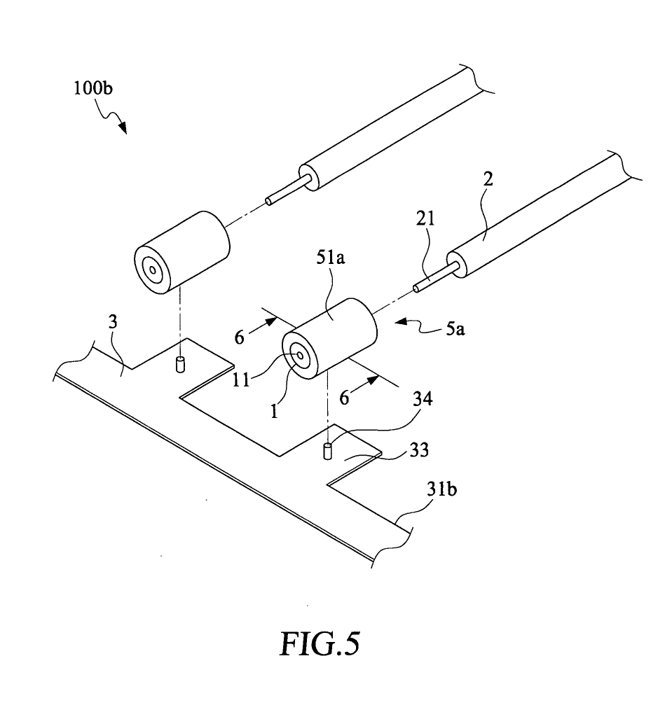

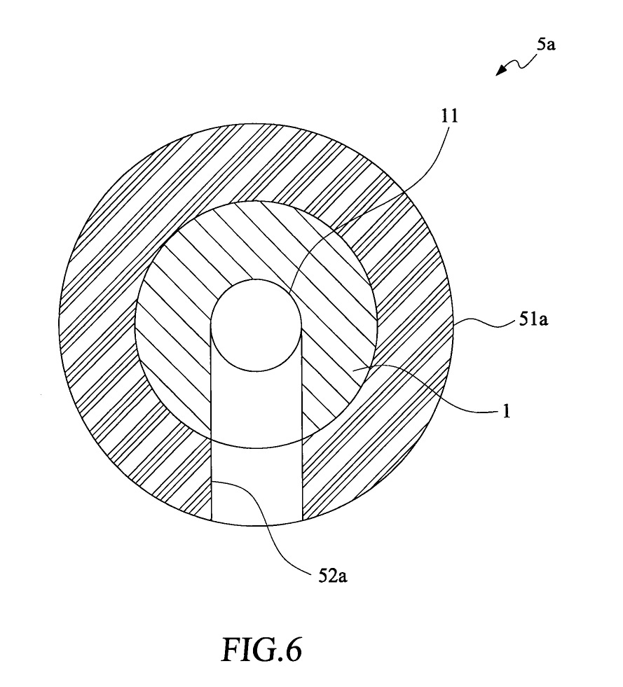

Please refer to FIG. 5 that is an exploded perspective view of a CCFL conductive device 100b according to a third embodiment of the present invention, and to FIG. 6 that is a cross-sectional view taken along line 6-6 of FIG. 5. The CCFL conductive device 100b is structurally and functionally similar to the second embodiment, and parts that are the same in the two embodiments will be denoted by the same reference numerals herein. The CCFL conductive device 100b is different from the CCFL conductive device 100a in having at least one holding unit 5a, each of which has a holding portion 51a in the form of a sleeve made of an insulative material. In the illustrated third embodiment, the holding portion 51a has an internal diameter corresponding to an external diameter of the coupling terminal 1 for fitly receiving the coupling terminal 1 therein. As can be seen from FIG. 6, the holding portion 51a is provided with a through hole 52a for engaging with the joint pin 34 provided on the sidewardly projected portion 33, so that the joint pin 34 is in electrical contact with the conductive element 21 of the CCFL 2 when the conductive element 21 is inserted into the insertion bore 11 of the coupling terminal 1 while the coupling terminal 1 is received in the holding portion 51a. It would be apparent to a person skilled in the art that two and more CCFLs 2 can also be associated with the CCFL conductive device 100b in the third embodiment of the present invention in the above-described manner.

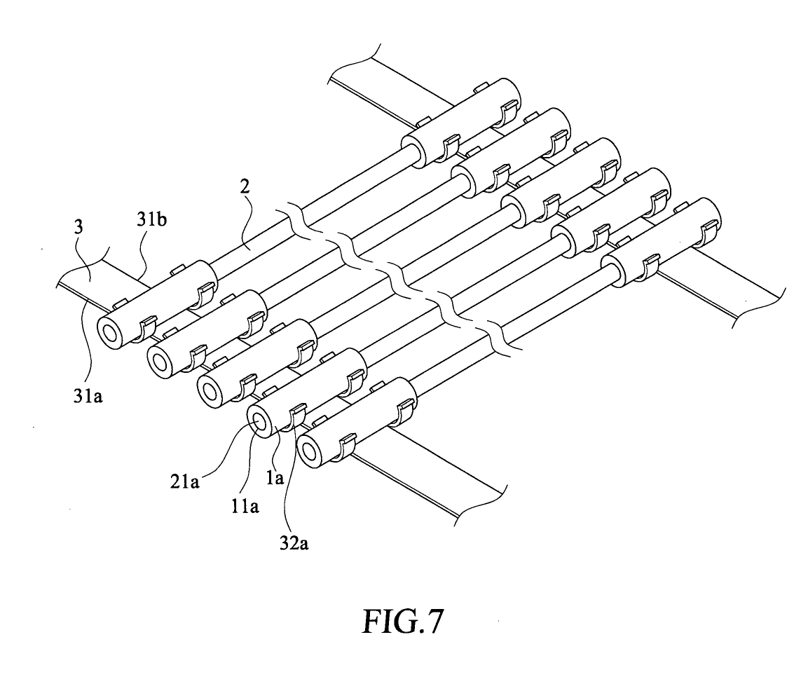

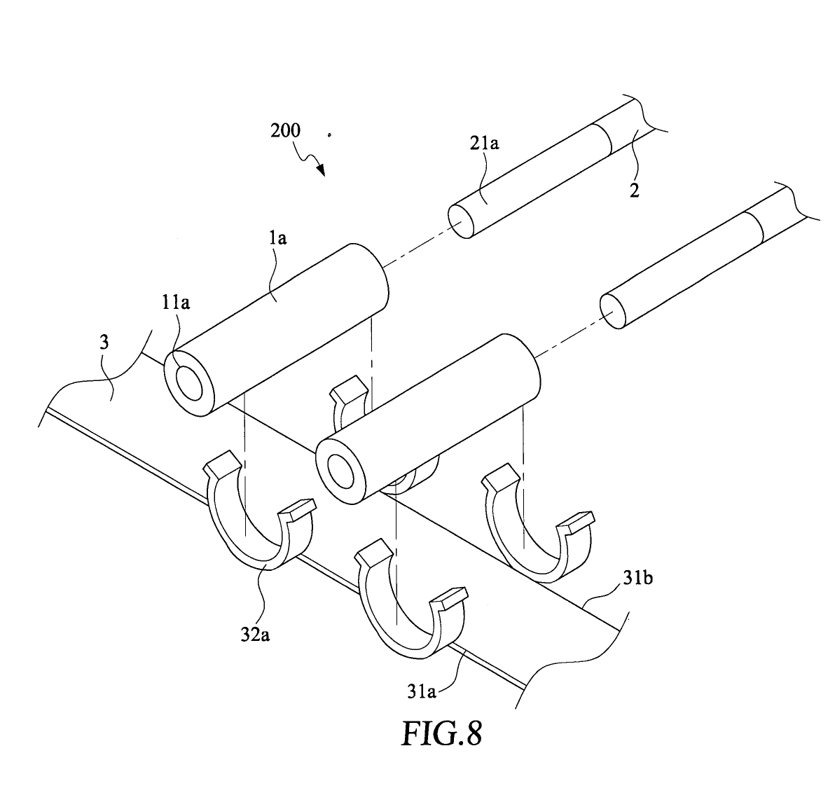

Please refer to FIGS. 7 and 8 that are assembled and exploded perspective views, respectively, showing a CCFL conductive device 200 according to a fourth embodiment of the present invention. The CCFL conductive device 200 is generally structurally and functionally similar to the CCFL conductive device 100 in the first embodiment, and parts that are the same in the two embodiments will be denoted by the same reference numerals herein. Unlike the CCFL conductive device 100, the CCFL conductive device 200 is designed to couple with a CCFL 2 having a conductive element 21a in the form of a conductive cap provided to each of two ends of the CCFL 2 to serve as an external electrode of the CCFL 2. The conductive element 21a has an outer diameter the same as an outer diameter of the CCFL 2. Accordingly, the CCFL conductive device 200 includes at least one coupling terminal 1a, which has an insertion bore 11a sized to fitly receive one conductive element 21a of the CCFL 2 therein, and at least one extended conductive segment 3 provided with at least one pair of conductive clips 32a for clamping the coupling terminal 1a therein. Since the manner for associating the conductive element 21a of the CCFL 2 with the CCFL conductive device 200 is the same as that in the first embodiment, it is not repeatedly described herein.

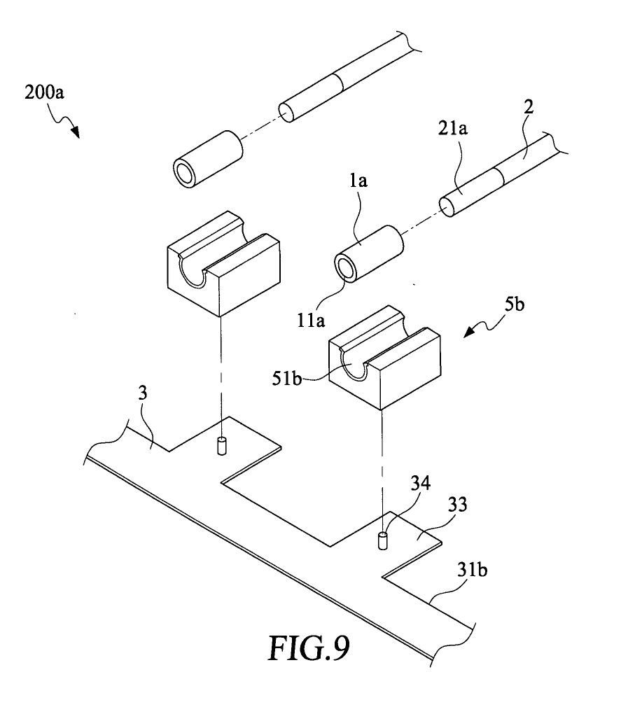

FIG. 9 is an exploded perspective view of a CCFL conductive device 200a according to a fifth embodiment of the present invention. The CCFL conductive device 200a is generally structurally and functionally similar to the CCFL conductive device 100a in the second embodiment, and parts that are the same in the two embodiments will be denoted by the same reference numerals herein. Unlike the CCFL conductive device 100a, the CCFL conductive device 200a is designed to couple with a CCFL 2 having a conductive element 21a in the form of a conductive cap and having an outer diameter the same as an outer diameter of the CCFL 2. Accordingly, the CCFL conductive device 200a includes at least one coupling terminal 1a, which has an insertion bore 11a sized to fitly receive one conductive element 21a of the CCFL 2 therein, and at least one holding unit 5b, which has a holding portion 51b with diameter and depth designed to fitly holding the coupling terminal 1a therein. Since the manner for associating the conductive element 21a of the CCFL 2 with the CCFL conductive device 200a is the same as that in the second embodiment, it is not repeatedly described herein.

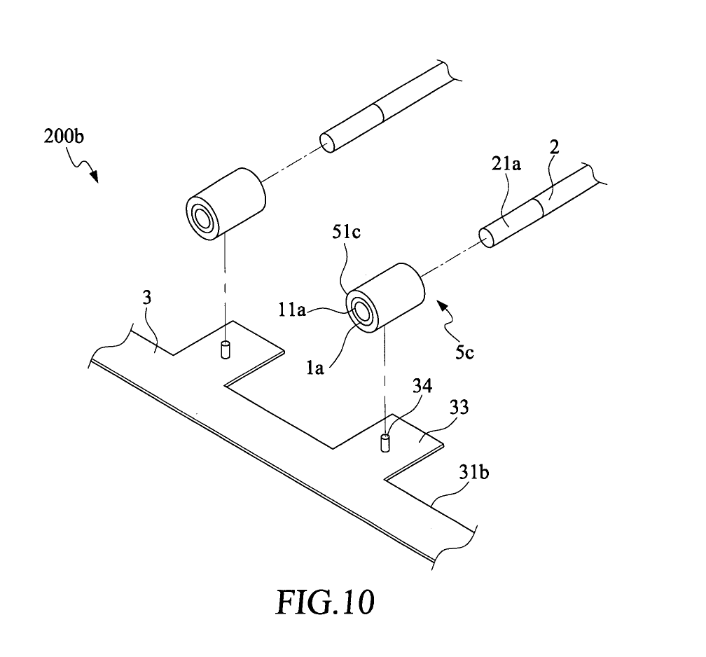

Please refer to FIG. 10, which is an exploded perspective view of a CCFL conductive device 200b according to a sixth embodiment of the present invention. The CCFL conductive device 200b is generally structurally and functionally similar to the CCFL conductive device 100b in the third embodiment, and parts that are the same in the two embodiments will be denoted by the same reference numerals herein. Unlike the CCFL conductive device 100b, the CCFL conductive device 200b is designed to couple with a CCFL 2 having a conductive element 21a in the form of a conductive cap and having an outer diameter the same as an outer diameter of the CCFL 2. Accordingly, the CCFL conductive device 200b includes at least one coupling terminal 1a, which has an insertion bore 11a sized to fitly receive one conductive element 21a of the CCFL 2 therein, and at least one sleeve-shaped holding unit 5c, which has a holding portion 51c with a diameter designed to fitly holding the coupling terminal 1a therein. Since the manner for associating the conductive element 21a of the CCFL 2 with the CCFL conductive device 200b is the same as that in the third embodiment, it is not repeatedly described herein.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A cold cathode fluorescent lamp conductive device for electrically connecting to a conducting element of at least one cold cathode fluorescent lamp, comprising:
at least one coupling terminal being provided with an insertion bore for the conductive element of the cold cathode fluorescent lamp to insert thereinto; and
at least one extended conductive segment being provided at predetermined positions with a plurality of spaced pairs of upward extended conductive clips; the conductive clips included in each pair being corresponding to each other for clamping one coupling terminal therein.

2. The cold cathode fluorescent lamp conductive device as claimed in claim 1, wherein the coupling terminal is in the form of an elongated column structure.

3. The cold cathode fluorescent lamp conductive device as claimed in claim 1, wherein the conductive element of the CCFL is a lamp lead wire.

4. The cold cathode fluorescent lamp conductive device as claimed in claim 1, wherein the conductive element of the CCFL is a conductive cap.

5. A cold cathode fluorescent lamp conductive device for electrically connecting to a conducting element of at least one cold cathode fluorescent lamp, comprising:
at least one coupling terminal being provided with an insertion bore for the conductive element of the cold cathode fluorescent lamp to insert thereinto;
at least an extended conductive segment being provided at predetermined positions with a plurality of spaced and sidewardly projected portions, and each of the sidewardly projected portions being provided with an upward extended joint pin; and
at least one holding unit having a holding portion for receiving one coupling terminal therein; the holding portion being internally provided with a through hole for engaging with the joint pin upward extended from the sideward projected portion, so that the joint pin is in electrical contact with the conductive element of the cold cathode fluorescent lamp being inserted into the coupling terminal.

6. The cold cathode fluorescent lamp conductive device as claimed in claim 5, wherein the holding portion of the holding unit is in the form of a concaved recess.

7. The cold cathode fluorescent lamp conductive device as claimed in claim 5, wherein the holding portion of the holding unit is in the form of a sleeve for receiving the coupling terminal therein.

8. The cold cathode fluorescent lamp conductive device as claimed in claim 5, wherein the coupling terminal is in the form of an elongated column structure.

9. The cold cathode fluorescent lamp conductive device as claimed in claim 5, wherein the conductive element of the cold cathode fluorescent lamp is a lamp lead wire.

10. The cold cathode fluorescent lamp conductive device as claimed in claim 5, wherein the conductive element of the cold cathode fluorescent lamp is a conductive cap.
